(19) United States
(12) Patent Application Publication
(10) Pub. No.: US 2007/0176434 A1
(43) Pub. Date: Aug. 2, 2007

(54) MOTOR VEHICLE LOCK

(75) Inventors: Roman JOSCHKO, Dormagen (DE); Ole HAGER, Witten (DE); Simon BROSE, Hattingen (DE)

Correspondence Address: ROBERTS, MLOTKOWSKI & HOBBES, P. O. BOX 10064, MCLEAN, VA, 22102-8064, US

(73) Assignee: BROSE SCHLIESSSYSTEME GMBH & CO. KG, Wuppertal (DE)

(21) Appl. No.: 11/538,895

(22) Filed: Oct. 5, 2006

(30) Foreign Application Priority Data
Oct. 5, 2005 (DE) 10 2005 015 687.6

(51) Int. Cl. E05C 3/06

(52) U.S. Cl. 292/216

(57) ABSTRACT

To embody and develop a known motor vehicle lock such that, with minimum construction effort, locking of the motor vehicle lock is also possible via the inside door handle, the central locking lever has, in addition to an unlocking contour that, by actuating the inside actuating lever in an opening direction and with the central locking lever in the locking position, is engaged by the inside actuating lever so as to transfer the central locking lever into the unlocking position and then disengages from the unlocking contour, is additionally provided with a locking contour via which the central locking lever is movable from the unlocking position into the locking position by actuating the inside actuating lever in a locking direction which is opposite the opening direction.

### BACKGROUND OF THE INVENTION

1. Field of the Invention

This invention relates to a motor vehicle lock with latching elements, such a latch and a ratchet, and with a lock mechanism for controlled actuation of the ratchet, the lock mechanism having an inside actuating lever which can be actuated from the inside door handle and a central locking lever which couples and decouples an outside door handle with the ratchet, the central locking lever being moved by a motor of a central locking drive into an unlocking position which couples the outside door handle to the ratchet and into a locking position which decouples the outside door handle, the central locking lever having an unlocking contour that, by actuating the inside actuating lever in the opening direction and with the central locking lever in the locking position, the inside actuating lever first engages the unlocking contour of the central locking lever, and in doing so, transfers the central locking lever into the unlocking position and then disengages from the unlocking contour.

2. Description of Related Art

The concept of the motor vehicle lock should be understood comprehensively. Not only side door locks and rear door locks, but also, for example, rear hatch locks are covered by it. Otherwise, the concept of motor vehicle lock entails the entire system with components which can also be distributed.

The known motor vehicle lock (European Patent Application 1 178 171 B1, U.S. Pat. No. 6,568,722) underlying the invention is equipped with conventional latching elements, such a latch and ratchet, and with a lock mechanism for controlled actuation of the ratchet. The ratchet can be actuated from an inside door handle or an outside door handle via the lock mechanism. For this purpose, the inside door handle is coupled to the inside actuating lever of the lock mechanism. To control access to the door or the like which is assigned to the motor vehicle lock from the outside, there is a central locking lever which couples the outside door handle to the ratchet or decouples the latter from it. The central locking lever can be moved accordingly into a locking position and into an unlocking position. For motorized movement of the central locking lever, the motor vehicle lock is equipped with the central locking drive.

The central locking lever in the known motor vehicle lock can be moved not only by a motor, but in any case in part also manually. It is specifically desirable that, by actuating the inside actuating lever in the opening direction, not only is the ratchet raised, but the central locking lever is automatically transferred into the unlocking position. On the other hand, the situation could occur that, when the central locking lever is in the locking position, the vehicle door is opened from the inside and after alighting is slammed again, without the central locking lever being transferred into the unlocking position. The user would then possibly be locked out.

In the known motor vehicle lock, the central locking lever has an unlocking contour, and by actuating the inside actuating lever in the opening direction with the central locking lever in the locking position, the inside actuating lever engages the unlocking contour, by which the central locking lever is transferred into the unlocking position. As actuation of the inside actuating lever continues, it disengages from the unlocking contour. Finally, the actuation of the inside actuating lever causes raising of the ratchet and opening of the vehicle door. The advantage, here, among others, is that the inside actuating lever, during raising of the ratchet, is free of the central locking lever, so that no additional retention force from the central locking lever acts on the inside actuating lever. The disadvantage is that manual locking of the motor vehicle lock, therefore manual movement of the central locking lever into the locking position, is associated with major construction effort.

Another known motor vehicle lock (European Patent 0 879 930 B1, U.S. Pat. No. 6,431,617) likewise shows coupling between the central locking lever and the inside actuating lever. Here, the central locking lever can be entrained via a spring when the inside actuating lever is actuated in the opening direction until the central locking lever runs against a stop in its unlocking position. As the inside actuating lever is further actuated against the pretensioning caused by the spring, the ratchet is raised. By actuating the inside actuating lever in the direction opposite the opening direction, the central locking lever is conversely entrained via a positive connection into its locking position. This is also called “push-pull actuation.” The disadvantage in this concept is the fact that the raising of the ratchet is associated by the actuation of the inside actuating lever with tensioning of the spring, therefore with increased expenditure of force, and furthermore, that the construction is complex. A similar concept is shown by the motor vehicle lock shown in German Utility Model 90 11 530 U1.

A motor vehicle lock with push-pull actuation is also shown by German Patent Application 197 27 638 A1 in which the inside actuating lever is equipped with an unlocking contour which interacts with a central locking lever. During raising of the ratchet by actuation of the inside actuating lever, the central locking lever is entrained into its unlocking position. The arrangement is such that the pivoting range of the inside actuating lever is limited by the continuing coupling between the inside actuating lever and the central locking lever. This can be disadvantageous in certain applications.

Another version for push-pull actuation in a motor vehicle lock is shown by European Patent Application 0 632 178 A1. Here, the inside actuating lever is, to a certain extent, motion-coupled to the central locking lever, by which major construction limitations arise.

For the sake of completeness, reference is made to German Patent DE 43 19 497 B4 which shows an outside door handle for push-pull actuation which is equipped at the same time with an actuator.

### SUMMARY OF THE INVENTION

A primary object of the present invention is to embody and develop the known motor vehicle lock such that, with minimum construction effort, locking of the motor vehicle lock is also possible via the inside door handle.

The aforementioned object is achieved in a motor vehicle lock of the initially mentioned type by the central locking lever having a locking contour via which the central locking lever can be moved into the locking position out of the unlocking position by actuating the inside actuating lever in a locking direction which is opposite the opening direction.

The consideration of equipping the central locking lever in addition with a locking contour via which the central locking lever can be moved out of the unlocking position into the locking position by actuating the inside actuating lever in the locking direction which is opposite the opening direction is important. The inside actuating lever is therefore coupled to the central locking lever via the unlocking contour, on the one hand, and the locking contour, on the other. With a corresponding design, it can be ensured that the central locking lever hinders the actuation of the inside actuating lever in the opening direction as little as possible, such that the actuation of the inside actuating lever in the opening direction is therefore associated with minimum force expenditure.

In a preferred configuration, the inside actuating lever can be moved out of an initial position, on the one hand, into the raised position, and on the other hand, into an activation position. In this connection, the unlocking contour, on the one hand, and the locking contour, on the other hand, are designed such that the initial position corresponds to the unlocking position of the central locking lever and the locking position corresponds to the locking position of the central locking lever.

In another preferred configuration, the inside actuating lever can be kept in the initial position or in the locking position by way of the locking contour or the unlocking contour. In this way, it is no longer necessary to assign a bi-stable leg spring to the inside actuating lever for the initial position, on the one hand, and the activation position, on the other.

Other preferred configurations call for an especially simple possibility of pretensioning of the inside actuating lever. Here, the inside actuating lever is provided solely for actuation out of the initial position in the opening direction. The inside actuating lever is moved between the initial position and the locking position without its own pretensioning.

In order to ensure a stable state in any position of the inside actuating lever, there is the above described coupling of the central locking lever by way of the unlocking contour and the locking contour. The central locking lever is pretensioned preferably with a bi-stable leg spring. This pretensioning is used to implement the desired stable state.

Another preferred configuration relates to coupling of the inside door handle to the inside actuating lever by way of a “push-pull” Bowden cable, the use of which enables a simple, and at the same time, compact configuration. The aforementioned coupling of the central locking lever with the inside actuating lever can be provided between these two levers, or indirectly by way of the Bowden cable coupled to the inside actuating lever, especially the end piece of the core of the Bowden cable which faces the inside actuating lever.

The invention is explained in detail below using one embodiment in conjunction with the accompanying drawings.

### BRIEF DESCRIPTION OF THE DRAWINGS

FIG. 1 shows a vehicle lock as in accordance with the invention in the uninstalled state,

FIG. 2 shows the vehicle lock of FIG. 1 as seen in the direction of arrow II, omitting the components not critical to the invention, and with the central locking lever in the locking position,

FIG. 3 is a rear view of the vehicle lock shown in FIG. 2,

FIG. 4 shows the vehicle lock of FIG. 2 with the central locking lever located in the unlocking position,

FIG. 5 shows the vehicle lock of FIG. 2 with the inside actuating lever in the raised position.

### DETAILED DESCRIPTION OF THE INVENTION

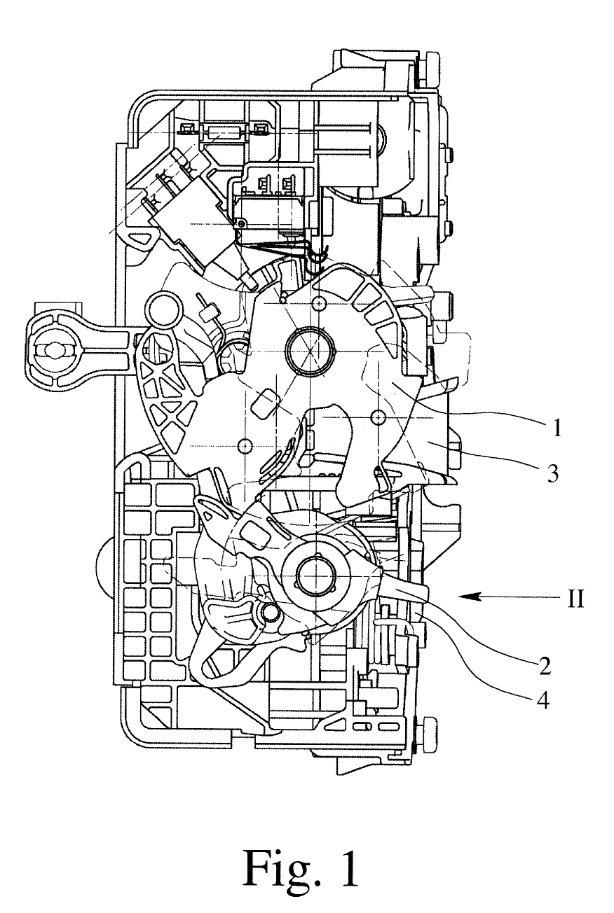

The vehicle lock shown in FIG. 1 shows the conventional latching elements latch 1 and ratchet 2 which are located in a housing. The housing has an inlet slot 3 via which a striker (not shown), and which is generally located on the body of the vehicle, engages the latch 1 when the vehicle door is shut. In FIG. 1, the ratchet 1 engages the latch 1 with blocking; this corresponds to the closed state of the vehicle door.

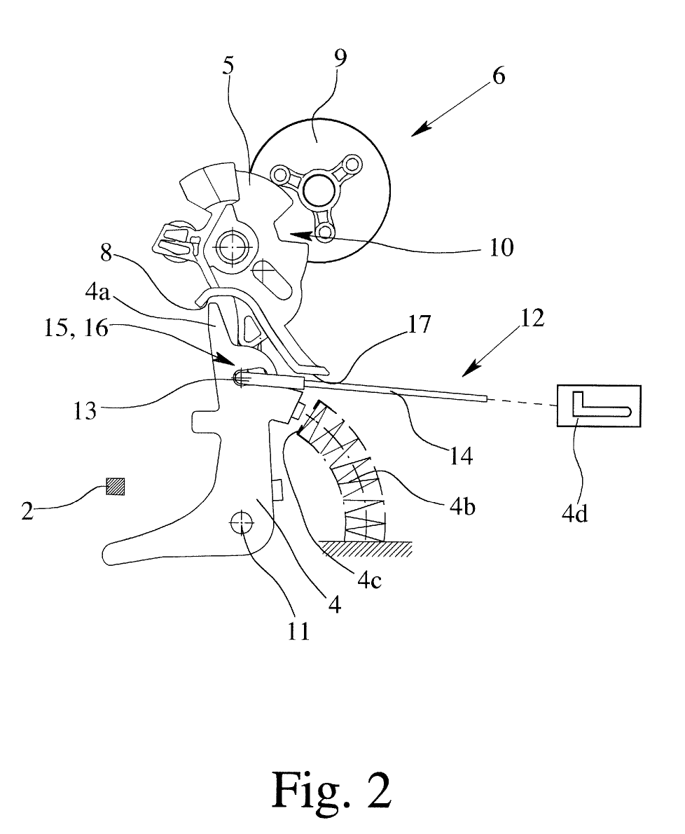

FIG. 2 shows part of the lock mechanism of the vehicle lock which is used for controlled actuation of the ratchet 2, which is shown here in a section. The lock mechanism is equipped with an inside actuating lever 4 which can be actuated from the inside door handle 4d. Furthermore, there is a central locking lever 5 which couples an outside door handle which is likewise not shown to the ratchet 2 or decouples it from the latter.

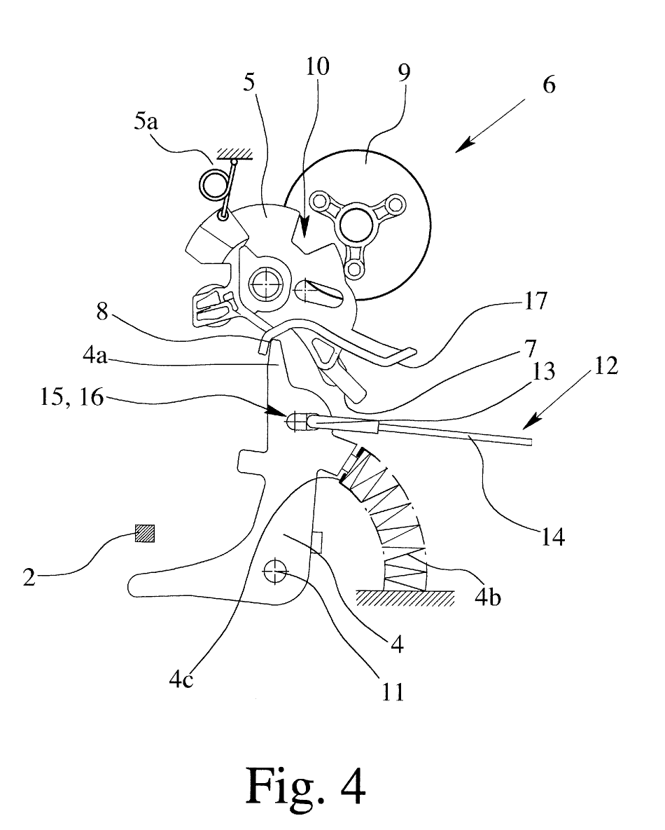

The central locking lever 5 can be moved by motor by the central locking drive 6 into an unlocking position which couples the outside door handle to the ratchet 2 and into a locking position which decouples the outside door handle. The locking position of the central locking lever 5 is shown in FIG. 2, the unlocking position of the central locking lever 5 is shown in FIG. 4.

It has already been mentioned that it is desirable for the central locking lever 5 to be moved automatically into the unlocking position when the inside actuating lever 4 is actuated in the opening direction. For this purpose, the central locking lever 5 has an unlocking contour 7, by actuating the inside actuating lever 4 in the opening direction and with the central locking lever 5 in the locking position, the inside actuating lever 4 first engages the unlocking contour 7 of the central locking lever 5, in doing so transferring the central locking lever 5 into the unlocking position and then disengaging from the unlocking contour 7. The fact that the inside actuating lever 4 finally disengages from the unlocking contour 7 is advantageous in that further actuation of the inside actuating lever 4 in the opening direction is not hindered by the central locking lever 5. A comparison of FIGS. 4 & 5 shows this actuation of the inside actuating lever 4 in the opening direction.

Details of the coupling between the inside actuating lever 4 and the central locking lever 5 are explained below.

At this point, it is important that the central locking lever 5 also has a locking contour 8, via which the central locking lever 5 can be moved into the locking position out of the unlocking position shown in FIG. 4 by actuating the inside actuating lever 4 in the locking direction which is opposite the opening direction. In FIGS. 2, 4 & 5, actuation of the inside actuating lever 4 in the opening direction corresponds to pivoting of the inside actuating lever 4 around to the right.

With the unlocking contour 7, on the one hand, and the locking contour 8, on the other, the position of the central locking lever 5 can be controlled completely via the inside actuating lever 4. As a result, the locking state of the vehicle lock can be set by way of the inside door handle 4d. This is achieved without the need to provide additional parts. Implementation costs are minimum with the corresponding one-piece design of the central locking lever 5.

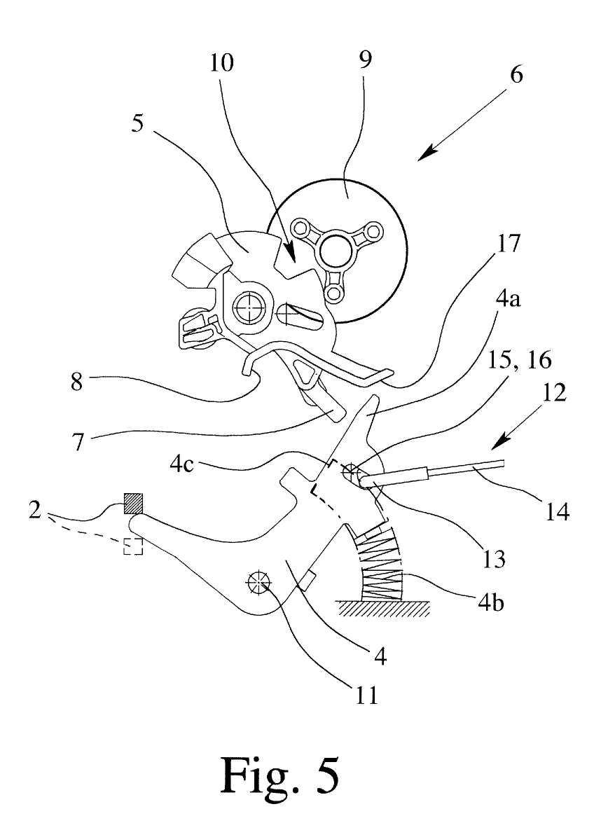

In order to be able to accomplish movement of the central locking lever 5, on the one hand, and raising of the ratchet 2, on the other, the inside actuating lever 4 can be moved into an initial position (FIG. 4), into a locking position (FIG. 2) and into a raising position (FIG. 5). The inside actuating lever 4 can be moved out of the initial position by actuation in the opening direction, in FIG. 4 to the right, into the raised position (FIG. 5), by which the ratchet 2 can be actuated. If, as shown in FIG. 4, the central locking lever 5 is in the unlocking position, the inside actuating lever 4 during its motion is disengaged from the central locking lever 5.

Furthermore, the inside actuating lever 4 can be moved out of the initial position, shown in FIG. 4, by actuation in the locking direction, in FIG. 4 to the left, into the activation (locking) position shown in FIG. 2, by which the central locking lever 5 can be moved from the unlocking position into the locking position. During its movement from the position shown in FIG. 4 into the position shown in FIG. 2, projection 4a of the inside actuating lever 4 presses the central locking lever 5 into the locking position via the locking contour 8.

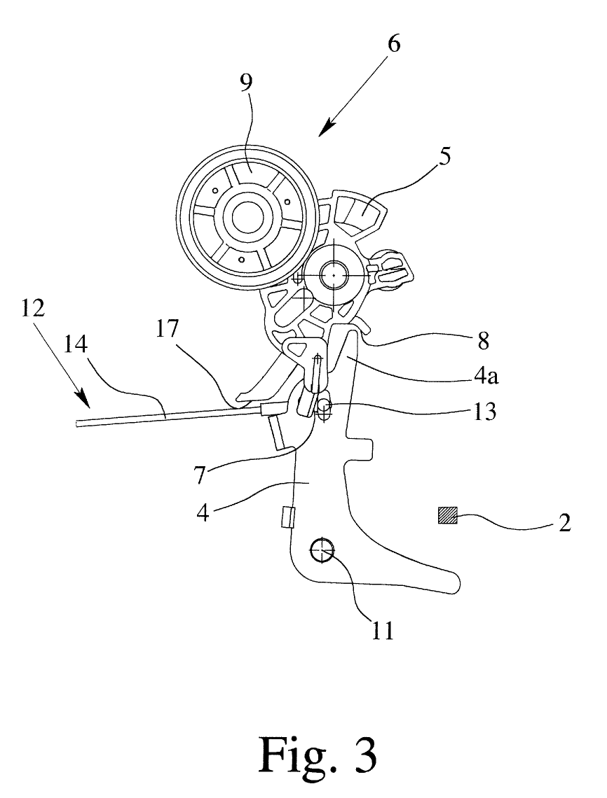

However, the central locking lever 5 can also be transferred by the inside actuating lever 4 back into the unlocking position. For this purpose, activation of the inside actuating lever 4 is necessary out of the activation (locking) position shown in FIG. 2, in the opening direction, until the inside actuating lever 4 again reaches the initial position shown in FIG. 4. The inside actuating lever 4, or the element 13 which is coupled to the inside actuating lever 4 and which is still to be explained in this connection, engages the unlocking contour 7 of the central locking lever 5. This is shown in FIG. 3.

It has already been explained that there is a central locking drive 6 for motorized movement of the central locking lever 5. The central locking drive 6, here, comprises a driving motor (not shown) and a positioning element 9 which interacts with the mouth-shaped recess 10 on the central locking lever 5 for moving it. Therefore, the central locking lever 5 can be moved, on the one hand, by motor via the central locking drive 6, and on the other hand, manually via the inside actuating lever 4 or via the inside door handle 4d.

In the motorized movement of the central locking lever 5, the position of the inside actuating lever 4 is tracked accordingly. Among other things, this has the advantage that the position of the inside door handle 4d corresponds fundamentally to the actual locking state. When the central locking lever 5 is moved by a motor from the locking position shown in FIG. 2 into the unlocking position, the locking contour 8 engages the projection 4a of the inside actuating lever 4, by which the inside actuating lever 4 is transferred into the initial position shown in FIG. 4. Conversely, when the central locking lever 5 travels by motor from the unlocking position shown in FIG. 4 into the locking position shown in FIG. 2, the unlocking contour 7 engages the inside actuating lever 4 in a manner yet to be explained and moves it into the activation (locking) position shown in FIG. 2.

In a preferred configuration which is easy to implement, the coupling between the inside actuating lever 4 and the central locking lever 5 is made at least in part by a direct coupling. This means that no other components are connected between the inside actuating lever 4 and the central locking lever 5 for coupling. Here, this applies, in any case, to the coupling between the projection 4a of the inside actuating lever 4 and the locking contour 8 of the central locking lever 5.

When the inside actuating lever 4 is in the initial position and in the activation position there is, furthermore, a quite definite coupling between the inside actuating lever 4 and the central locking lever 5. In the situation shown in FIG. 4, specifically, when the central locking lever 5 is in the unlocking position and when the inside actuating lever 4 is in the initial position, the locking contour 8 of the central locking lever 5 is engaged with the inside actuating lever 4 and keeps the inside actuating lever 4 in the initial position with respect to actuation in the locking direction. FIGS. 2 & 3 show, conversely, that when the inside actuating lever 4 is in the activation position, the unlocking contour 7 of the central locking lever 5 is engaged with the inside actuating lever 4 and keeps the inside actuating lever 4 in the activation position with respect to actuation in the opening direction. Thus, an especially simple form of pretensioning of the inside actuating lever 4 is possible.

In an especially preferred configuration, the inside actuating lever 4 is pretensioned such that actuation out of the initial position in the opening direction takes place against this pretensioning and that actuation between the initial position and the activation position takes place without its own pretensioning. Therefore, the inside actuating lever 4 can, fundamentally, be freely moved between the initial position and the activation position, provided that the inside actuating lever 4 does not hinder movement of the central locking lever 5, as described above.

For pretensioning of the inside actuating lever 4, in a preferred configuration, there is a spring element 4b (shown as an example in FIGS. 2, 4, 5) which, when the inside actuating lever 4 has been actuated out of the initial position in the opening direction, is engaged with the inside actuating lever 4 for its pretensioning and which disengages from the inside actuating lever 4 when the inside actuating lever 4 has been actuated out of the initial position in the locking direction. The spring element 4b can be, for example, a helical spring (FIGS. 2, 4, 5) with one end supported on the housing of the vehicle lock and the other end being engaged with the inside actuating lever 4 when the inside actuating lever 4 has been actuated out of the initial position in the opening direction. As soon as the inside actuating lever 4 then reaches the position between the initial position and the activation (locking) position, the helical spring 4b engages a shoulder 4c or the like on the housing and can no longer follow the motion of the inside actuating lever 4. The inside actuating lever 4 is to a certain extent free of the pretensioning of the helical spring 4b. Here, all conceivable versions of spring elements can also be used. Another example would be the use of a tension spring.

The central locking lever 5, in an especially preferred configuration, is pretensioned into the locking position and into the unlocking position by means of a bi-stable leg spring 5a which is shown, by way of example, in FIG. 4. Numerous versions are conceivable for possible implementation of this pretensioning.

The pretensioning of the inside actuating lever 4, the pretensioning of the central locking lever 5 and the above described coupling of the central locking lever 5 to the inside actuating lever 4 in any locking state provide for a defined position of the inside actuating lever 4. It is especially such that the central locking lever 5 in the non-pretensioned range of motion of the inside actuating lever 4 to a certain extent “replaces” the lack of pretensioning of the inside actuating lever 4. Superposition of pretensioning is thus largely avoided; this basically leads to low actuating forces.

In the illustrated preferred embodiment, the engagement point is between the inside actuating lever 4 and the locking contour 8, viewed in the direction of the axis 11 of the inside actuating lever 4, in a plane that is different from that of the engagement point between the inside actuating lever 4 and the unlocking contour 7. Thus, the inside actuating lever 4 can be actuated in the opening direction when the central locking lever 5 is in the unlocking position without further engagement with the central locking lever 5. If this “offset” of the two engagement points were not provided, the projection 4a of the inside actuating lever 4 would collide with the unlocking contour 7 upon actuation in the opening direction.

In FIGS. 2 to 5, it is shown that the inside actuating lever 4 is coupled via a Bowden cable 12 to the inside door handle 4d, the Bowden cable 12 being made as a “push-pull” Bowden cable and the inside door handle 4d being able to move accordingly out of the initial position into a raised position, on the one hand, and into the activation position or locking position, on the other hand. With this Bowden cable, the movement of the inside door handle 4d is transmitted to the inside actuating lever 4, and accordingly, to the central locking lever 5, and oppositely, the movement of the inside actuating lever 4 or central locking lever 5 is transmitted to the inside door handle 4d. The Bowden cable 12 constitutes a simple and compact possibility of coupling. However, all other energy transmission means conceivable here can also be used.

The existence of the Bowden cable 12 in one especially preferred configuration can be used for special coupling between the inside actuating lever 4 and the central locking lever 5. Specifically, a coupling can be provided between the inside actuating lever 4 and the unlocking contour 7 via the Bowden cable 12 coupled to the inside actuating lever 4, preferably via the end piece 13 of the core 14 of the Bowden cable 12. This is shown in FIG. 3. The end piece 13 of the Bowden cable 12 is made as a shape which is engaged by the inside actuating lever 4. On the other hand, the end piece 13, in the state shown in FIG. 3, is engaged with the unlocking contour 7 of the central locking lever 5 so that, as described above, the inside actuating lever 4 is held in the activation position by the central locking lever 5.

In another preferred configuration, the Bowden cable 12 is coupled to the inside actuating lever 4 via a trip-free (lost motion) mechanism 15. This trip-free mechanism 15 is implemented here by a slot 16 which is located in the inside actuating lever 4 and which is engaged by the end piece 13 of the core 14 of the Bowden cable 12.

It has already been explained that FIG. 2 shows the inside actuating lever 4 in the activation position and the central locking lever 5 in the locking position. In this state of the vehicle lock, if the Bowden cable 12 is actuated by tension, in FIG. 2 to the right, the movement of the inside actuating lever 4 is preceded first by movement of the central locking lever 5. The central locking lever 5 is to a certain extent “pre-actuated” during passage of the trip-free mechanism 15 so that a comparatively small movement of the inside actuating lever 4 is necessary for moving the central locking lever 5. This is advantageous since there is often no raising of the ratchet 2 in this type of actuation of the inside actuating lever 4, therefore the raised position of the inside actuating lever 4 will not be reached.

In the aforementioned connection, reference should be made to the special configuration of the unlocking contour 7. As shown in FIGS. 2 & 3, the unlocking contour 7 is made as a downwardly protruding arm of the central locking lever 5. This arrangement of the arm of the central locking lever 5, to a certain extent, moves unlocking forward when the inside actuating lever 4 is actuated in the opening direction out of the activation position. This, in turn, makes it possible to ensure unlocking of the vehicle lock via the inside actuating lever 4 without the need to raise the ratchet 2. The ratchet 2 can be raised here specifically with respect to actuation in the opening direction only after movement of the central locking lever 5 into the unlocking position.

Furthermore, FIG. 5 shows that the central locking lever 5 has a blocking contour 17 which can be caused to engage the inside actuating lever 4 when the inside actuating lever 4 is actuated in the opening direction and when the central locking lever 5 is in the unlocking position, and blocks movement of the central locking lever 5 into the locking position. In the state shown in FIG. 5, movement of the central locking lever 5 in the direction of the locking position, in FIG. 5 around to the right, would lead to the blocking contour 17 engaging the projection 4a of the inside actuating lever 4 and remaining in this position.

FIG. 5 also shows that the locking contour 8 passes into the blocking contour 17 and that the locking contour 8, viewed in the direction of the axis 11 of the inside actuating lever 4, lies essentially in the same plane as the blocking contour 17.

However, basically, it can also be provided that the unlocking contour 7 is a component of the locking contour 8 and the blocking contour 17 so that all three contours are combined in a single coherent contour. This requires a quite certain arrangement and configuration of the inside actuating lever 4, on the one hand, and the central locking lever 5, on the other hand.

With respect to an economical and durable configuration, it is especially advantageous if the central locking lever 5 is made integral with the unlocking contour 7 and with the locking contour 8 as well as with the blocking contour 17 which may be present. Basically, of course, a multipart configuration is also possible.

In the illustrated preferred embodiment, the inside actuating lever 4 can be caused to directly engage the ratchet 2. However, it can also be provided that a ratchet lever or the like is connected between the inside actuating lever 4 and the ratchet 2.

It is pointed out that the vehicle lock can be provided with other conventional lock functions without departing from the design in accordance with the invention. These lock functions include the double lock function, child safety function, or the like.

In summary, locking and unlocking of the vehicle lock via a “push-pull” function of the inside door handle 4d is easily possible with the design of the invention. The sole construction elements necessary for this purpose are the locking contour 8, on the one hand, and the unlocking contour 7, on the other hand, which can be made integral with the central locking lever 5 so that, as a result, no additional parts are necessary for implementation of the design in accordance with the invention.

What is claimed is:

1. Motor vehicle lock, comprising:
latching elements including a latch and a ratchet,
a lock mechanism for controlled actuation of the ratchet, the lock mechanism having an inside actuating lever which is actuable by an inside door handle and a central locking lever for coupling and uncoupling an outside door handle with the ratchet, and
central locking drive for moving the central locking lever into an unlocking position which couples the outside door handle to the ratchet and into a locking position which decouples the outside door handle, the central locking lever having an unlocking contour that, by actuating the inside actuating lever in an opening direction and with the central locking lever in the locking position, is engaged by the inside actuating lever so as to transfer the central locking lever into the unlocking position and then disengages from the unlocking contour,
wherein the central locking lever also has a locking contour via which the central locking lever is movable from the unlocking position into the locking position by actuating the inside actuating lever in a locking direction which is opposite the opening direction.

2. Motor vehicle lock as claimed in claim 1, wherein the inside actuating lever is movable from an initial position into a raised position by actuation in the opening direction, by which the ratchet is actuable; wherein the inside actuating lever is movable from the initial position into the locking position by actuation in the locking direction, by which the central locking lever is movable from the unlocking position into the locking position; and wherein the inside actuating lever is movable from the locking position into the initial position by actuation in the opening direction, by which the central locking lever is movable from the locking position into the unlocking position.

3. Motor vehicle lock as claimed in claim 2, wherein the inside actuating lever is movable from the locking position into the initial position by the central locking drive via the locking contour, and wherein the inside actuating lever is movable from the initial position into the locking position by the central locking drive via the unlocking contour.

4. Motor vehicle lock as claimed in claim 2, wherein the coupling between the inside actuating lever and the central locking lever comprises a direct coupling.

5. Motor vehicle lock as claimed in claim 2, wherein, when the central locking lever is in the unlocking position and when the inside actuating lever is in the initial position, the locking contour of the central locking lever is engaged with the inside actuating lever and keeps the inside actuating lever in the initial position with respect to actuation in the locking direction, and wherein, when the inside actuating lever is in the locking position, the unlocking contour of the central locking lever is engaged with the inside actuating lever and keeps the inside actuating lever in the locking position with respect to actuation in the opening direction.

6. Motor vehicle lock as claimed in claim 4, wherein, when the central locking lever is in the unlocking position and when the inside actuating lever is in the initial position, the locking contour of the central locking lever is engaged with the inside actuating lever and keeps the inside actuating lever in the initial position with respect to actuation in the locking direction, and wherein, when the inside actuating lever is in the locking position, the unlocking contour of the central locking lever is engaged with the inside actuating lever and keeps the inside actuating lever (4) in the locking position with respect to actuation in the opening direction.

7. Motor vehicle lock as claimed in claim 2, wherein the inside actuating lever is pretensioned such that actuation out of the initial position in the opening direction takes place against the pretensioning, and that actuation between the initial position and the locking position takes place without said pretensioning.

8. Motor vehicle lock as claimed in claim 7, further comprising a spring element which, when the inside actuating lever has been actuated out of the initial position in the opening direction, is engaged with the inside actuating lever for producing said pretensioning, and which is disengaged from the inside actuating lever when the inside actuating lever has been actuated out of the initial position in the locking direction.

9. Motor vehicle lock as claimed in claim 5, wherein the central locking lever is pretensioned into the locking position and into the unlocking position by means of a bi-stable leg spring.

10. Motor vehicle lock as claimed in claim 1, wherein an engagement point of the inside actuating lever with the locking contour, viewed in a direction of a pivot axis of the inside actuating lever, is in a plane other than that containing an engagement point of the inside actuating lever with the unlocking contour so that the inside actuating lever is actuable in the opening direction when the central locking lever is in the unlocking position without engagement with the central locking lever.

11. Motor vehicle lock as claimed in claim 2, wherein the inside actuating lever is coupled via a Bowden cable to the inside door handle, the Bowden cable being a push-pull Bowden cable, and wherein the inside door handle is movable out of the initial position into a raised position and into a locking position, wherein the Bowden cable is coupled to the inside actuating lever via a trip-free lost motion mechanism so that, when the Bowden cable is activated with the inside actuating lever in the locking position and the central locking lever in the locking position, the movement of the inside actuating lever is preceded by movement of the central locking lever.

12. Motor vehicle lock as claimed in claim 11, further comprising a coupling between the inside actuating lever and the unlocking contour via the Bowden cable which is coupled to the inside actuating lever.

13. Motor vehicle lock as claimed in claim 1, wherein the central locking lever has a blocking contour which is engageable with the inside actuating lever when the inside actuating lever is actuated in the opening direction and the central locking lever is in the unlocking position, and then blocks movement of the central locking lever into the locking position.

14. Motor vehicle lock as claimed in claim 13, wherein the locking contour merges into the blocking contour.

15. Motor vehicle lock as claimed in claim 13, wherein the central locking lever is integral with the unlocking contour, the locking contour and the blocking contour.

16. Motor vehicle lock as claimed in claim 1, wherein the inside actuating lever is directly engageable with the ratchet.
